(19) United States
(12) Patent Application Publication
(10) Pub. No.: US 2026/0092785 A1
(43) Pub. Date: Apr. 2, 2026

(54) TRANSPORTATION DETERMINING METHOD AND TRANSPORTATION DETERMINING AND TRANSPORT FARE CALCULATING SYSTEM

(71) Applicant: David LU, Taichung (TW)

(72) Inventor: David LU, Taichung (TW)

(21) Appl. No.: 18/923,744

(22) Filed: Oct. 23, 2024

(30) Foreign Application Priority Data
Sep. 30, 2024 (TW) 113137422

(51) Int. Cl. G01C 21/34; G01C 21/36; G06Q 30/0207; G06Q 30/0283

(52) U.S. Cl. CPC G01C 21/3423; G01C 21/3492; G01C 21/3691; G06Q 30/0207; G06Q 30/0284

(57) ABSTRACT

A transportation detecting method includes the following steps of: a server detecting and obtaining a moving parameter of a travel after receiving a travel starting signal from an electronic device, wherein the moving parameter includes a moving track, a moving speed and a stay location; and the server determining a transportation type of a transportation taken by the electronic device according to the moving parameter.

### BACKGROUND OF THE INVENTION

### 1. Field of the Invention

The present invention relates to a transportation determination and fare calculation, especially to a transportation determining method and transportation determining and transport fare calculating system that can automatically determine the transportation type taken by a user and calculate the transport fare.

### 2. Description of the Prior Art

Public transportation is one of the modes of transportation taken by many people. In general, people need to buy tickets before taking public transportation (such as trains and buses). However, when people are traveling long distances and are not sure about the way and route to the destination, they cannot purchase tickets in advance and it will become quite troublesome. Furthermore, if people are busy and have to queue up to buy tickets, it will not only reduce travel efficiency but also increase time costs, thereby hindering people's willingness to take public transportation. In addition, the current ticket purchasing system can only display the timetable of public transportation, but cannot show the congestion level of public transportation. If people take high-crowded public transportation, their comfort level will be reduced.

Therefore, it is necessary to develop a new travel route planning and transport fare calculating mechanism to solve the problems of the prior art.

### SUMMARY OF THE INVENTION

Therefore, one category of the present invention provides a transportation detecting method. According to an embodiment of the present invention, transportation detecting method including the following steps of: a server detecting and obtaining a moving parameter of a travel after receiving a travel starting signal from an electronic device, wherein the moving parameter includes a moving track, a moving speed and a stay location; and the server determining a transportation type of a transportation taken by the electronic device according to the moving parameter.

Wherein, the transportation detecting method further includes the following step of: the server calculating a moving route information of the electronic device according to the moving parameter, and calculating a transport fare according to the moving route information and the transportation type.

Wherein, the transportation detecting method further includes the following steps of: the electronic device inputting the travel starting signal, wherein the travel starting signal includes a first position and a second position, and a travel route is formed between the first position and the second position; the server generating at least one recommend transportation according to the travel route; and the electronic device selecting the at least one recommend transportation according to a user command.

Furthermore, the transportation detecting method includes the following step of: the server generating a traffic congestion degree corresponding to at least one of the travel starting signal and the travel route; and, in the step of the electronic device selecting the at least one recommend transportation according to the user command, further includes the step of: the electronic device selecting the at least one recommend transportation according to the user command and the traffic congestion degree.

Wherein, in the step of the server calculating the transport fare according to the moving route information and the transportation type, further includes the step of: the server calculating the transport fare according to a riding time length of the transportation taken by the electronic device, the moving route information and the transportation type.

Wherein, the transportation detecting method further includes the following step of: the server detecting and calculating the moving parameters of a plurality of other electronic devices located within a detection range of the electronic device; and, in the step of the server determining the transportation type of the transportation taken by the electronic device according to the moving parameter, further includes the following step of: the server determining the transportation type of the transportation taken by the electronic device according to the number of the other electronic devices with the same moving parameter of the electronic device.

Furthermore, the transportation detecting method includes the following steps of: the server generating a congestion degree corresponding to the transportation according to the number of the other electronic devices with the same moving parameter of the electronic device; and the server calculating the moving route information according to the moving parameter, and calculating the transport fare according to the congestion degree, the moving route information and the transportation type.

Wherein, the transportation detecting method further includes the following step of: the server counting at least one of the moving parameter, the transportation type and the moving route information to generate a total travel data corresponding to the electronic device, and generating a green energy reward according to the total travel data.

Another one category of the present invention provides a transportation detecting and transport fare calculating system to solve the problems of prior art.

According to an embodiment of the present invention, the transportation detecting and transport fare calculating system includes an electronic device and a server, and the electronic device and the server are communicated with each other. The electronic device includes an input unit configured to input a travel starting signal. The server is configured to receive the travel starting signal from the electronic device and includes a position detecting unit, an analysis unit and a charge calculating unit. The position detecting unit is configured to detect a moving parameter of a travel of the electronic device according to the travel starting signal, wherein the moving parameter includes a moving track, a moving speed and a stay location. The analysis unit is configured to determine a transportation type of a transportation taken by the electronic device and a moving route information of the electronic device according to the moving parameter. The charge calculating unit is connected to the analysis unit and configured to calculate a transport fare according to the moving route information and the transportation type.

Wherein, the travel starting signal includes a first position and a second position, and a travel route is formed between the first position and the second position. The analysis unit is configured to generate at least one recommend transportation according to the travel route. The electronic device is configured to select the at least one recommend transportation according to a user command.

Wherein, the analysis unit is configured to generate a traffic congestion degree corresponding to at least one of the travel starting signal and the travel route, and the electronic device is configured to select the at least one recommend transportation according to the user command and the traffic congestion degree.

Wherein, the charge calculating unit is connected to the position detecting unit, and the position detecting unit is configured to record a riding time length of the transportation taken by the electronic device. The charge calculating unit is configured to calculate the transport fare according to the riding time length, the moving route information and the transportation type.

Wherein, the position detecting unit is configured to detect and calculate the moving parameters of a plurality of other electronic devices located within a detection range of the electronic device, and the analysis unit is configured to determine the transportation type according to the number of the other electronic devices with the same moving parameter of the electronic device.

Furthermore, the analysis unit is configured to generate a congestion degree corresponding to the transportation according to the number of the other electronic devices with the same moving parameter of the electronic device, and the charge calculating unit is configured to calculate the transport fare according to the congestion degree, the moving route information and the transportation type.

Wherein, the charge calculating unit is configured to count at least one of the moving parameter, the transportation type and the moving route information to generate a total travel data corresponding to the electronic device, and generate a green energy reward according to the total travel data.

In summary, the transportation determining method and the transportation determining and transport fare calculating system of the present invention have four major functional features of: comprehensively promote convenience, fairness, prediction and green energy. The transportation determining method and the transportation determining and transport fare calculating system can automatically determine the transportation type taken by the user through real-time positioning and moving parameter detection, and can automatically calculate transport fare according to the electrical map, the moving parameter and the transportation type. The users do not need to spend a lot of time queuing to buy tickets, thereby saving time and improving efficiency and convenience. Furthermore, the transportation determining method and the transportation determining and transport fare calculating system can present the traffic congestion degree of each travel route and the congestion degree of the transportation immediately, and the user can select transportation according to the congestion degree, thereby increasing the usability and predictability. Moreover, the transportation determining method and the transportation determining and transport fare calculating system also can adjust transport fare according to the congestion degree and/or riding time length taken by the user, thereby increasing fairness and comfort.

### BRIEF DESCRIPTION OF THE APPENDED DRAWINGS

FIG. 1 is a flow chart diagram illustrating a transportation determining method in an embodiment of the present invention.

FIG. 2 is a function block diagram illustrating a transportation determining and transport fare calculating system in an embodiment of the present invention.

FIG. 3 is a flow chart diagram illustrating the transportation determining method in an embodiment of the present invention.

FIG. 4 is a simply schematic diagram illustrating a travel route and an electrical map in an embodiment of the present invention.

FIG. 5 is a simply schematic diagram illustrating the travel routes and the electrical map in an embodiment of the present invention.

FIG. 6 is a flow chart diagram illustrating the transportation determining method in an embodiment of the present invention.

FIG. 7 is a flow chart diagram illustrating the transportation determining method in an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

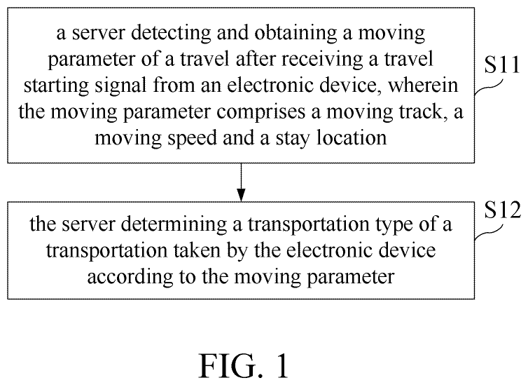

Please refer to FIG. 1. FIG. 1 is a flow chart diagram illustrating a transportation determining method in an embodiment of the present invention. As shown in FIG. 1, in this embodiment, the transportation determining method includes the following steps of: step S11: a server detecting and obtaining a moving parameter of a travel after receiving a travel starting signal from an electronic device, wherein the moving parameter includes a moving track, a moving speed and a stay location; and step S12: the server determining a transportation type of a transportation taken by the electronic device according to the moving parameter.

In step S11, the electronic device can be a user's smart phone, tablet and laptop, and can have a positioning chip. The server can be a cloud server and a central management server, and can communicate with electronic device through wireless transmission. The travel starting signal can be the starting location information that the user wants to go to a destination, and the travel starting signal can be a signal, command, address, message, etc. In practice, the electronic device can install an electronic tracking system/platform (such as the electrical map, Google Map) to input the travel starting signal, and then send the travel starting signal to the server.

In practice, the electronic device and the server can communicate with the GPS satellites respectively. The GPS satellites can position the location of the electronic device according to the positioning chip of the electronic device. After receiving the travel starting signal from the electronic device, the server can obtain the current location of the electronic device through the GPS satellites, and detect and obtain the moving parameter through the GPS satellites. In the moving parameter, the moving track can be moving direction and moving path of the electronic device (that is the user). The moving speed can be current moving speed of the electronic device, or average moving speed when the electronic device moves a certain distance (or a certain time length). The stay location can be the position of the destination, or the positions where the electronic device briefly stops on its way to the destination. Moreover, the moving parameter can further include a time, wherein the time can be the timestamp when the electronic device inputs the travel starting signal, or it can be the time length when the electronic device to moves a certain distance.

In step S12, the server can determine the transportation and the transportation type taken by the user according to at least one of the moving track, moving speed and stay location of the moving parameter. For example, when detecting the moving speed of the electronic device is between 80 km/hr and 300 km/hr, the server can determine that the user takes train or high-speed rail to the destination; when detecting the average moving speed of the electronic device is between 15 km/hr and 60 km/hr, the server can determine that the user takes bus to the destination; when detecting the moving track and stay locations of the electronic device are same as the driving route and bus stop signs of a bus and the average moving speed of the electronic device is between 15 km/hr and 60 km/hr, the server can determine that the user takes bus to the destination. In one embodiment, when detecting the moving speed between the first timestamp and the second timestamp of the electronic device is between 80 km/hr and 300 km/hr, the server can determine that the user takes train or high-speed rail to the destination. Moreover, when detecting the moving speed of the electronic device is less than 6 km/hr, the server can determine that the user forward to the destination by walk and doesn't take transportation.

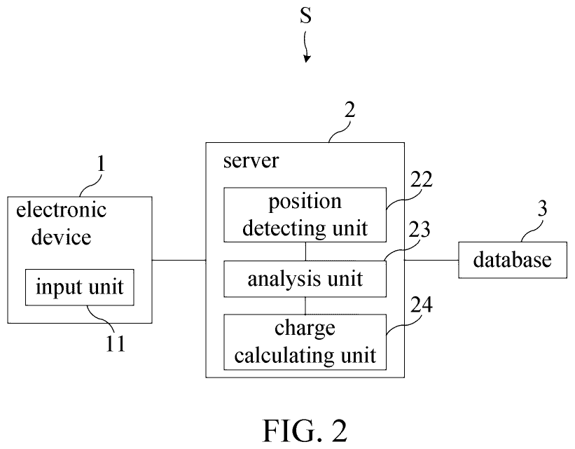

Please refer to FIG. 1 and FIG. 2. FIG. 2 is a function block diagram illustrating a transportation determining and transport fare calculating system S in an embodiment of the present invention. The steps in FIG. 1 can be achieved by the transportation determining and transport fare calculating system S in FIG. 2. As shown in FIG. 2, in this embodiment, the transportation determining and transport fare calculating system S includes an electronic device 1 and a server 2 communicated with each other. The electronic device 1 includes an input unit 11, and the input unit 11 is configured to input a travel starting signal. In practice, the input unit 11 can be a keyboard, mouse, touch screen, touch pen, virtual keyboard/button. The user can input the travel starting signal on the aforementioned electronic tracking system/platform by the input unit 11.

In this embodiment, the server 2 includes a position detecting unit 22 and an analysis unit 23. The position detecting unit 22 is configured to detect and obtain the moving parameter of the electronic device 1 according to the travel starting signal. In practice, the position detecting unit 22 can be a position measuring chip. The position detecting unit 22 can obtain the current location and the aforementioned moving parameter of the electronic device 1 through the GPS satellites and electrical map. The analysis unit 23 is connected to the position detecting unit 22. The analysis unit 23 is configured to determine the transportation type of the transportation taken by the electronic device 1 according to the moving parameter. In practice, the analysis unit 23 can be an analyzing and calculating chip. The analysis unit 23 can determine the transportation and transportation type taken by the user according to the moving track, moving speed and stay location of the moving parameter obtained by the position detecting unit 22.

In practice, when the user follows habits and experience and does not have a specific route to the destination, the user can input the travel starting signal without accurate position through the electronic device 1. At this time, the position detecting unit 22 of the server 2 can immediately position the current location of the user, and continuously detect and record the moving parameter of the user. Then, the analysis unit 23 of the server 2 analyzes and determines the way the user heading to the destination according to the moving parameter obtained by the position detecting unit 22.

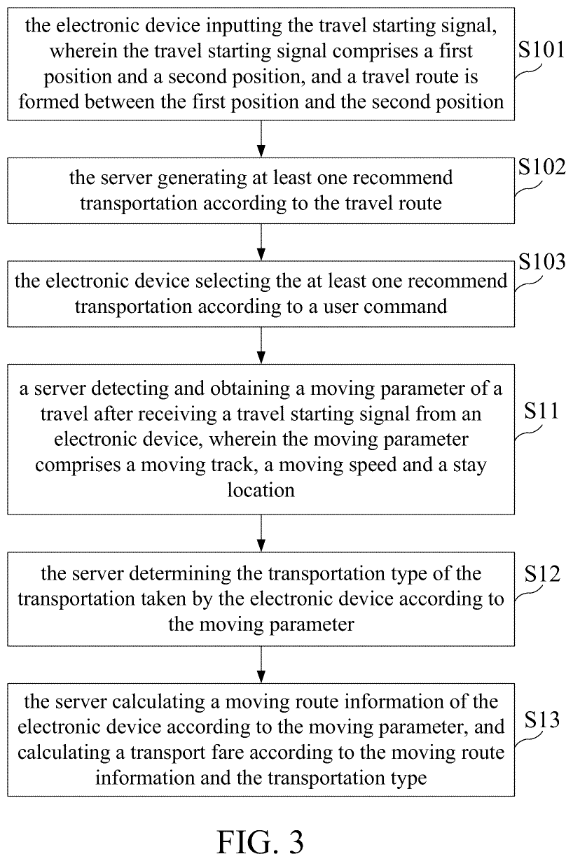

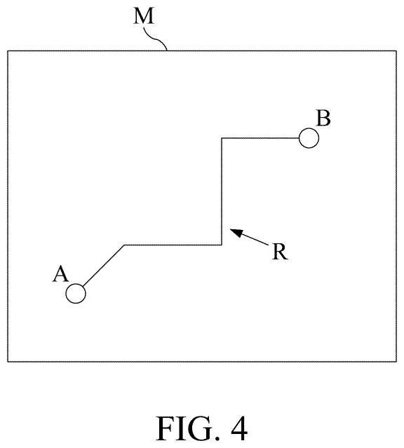

Please refer to FIG. 1 to FIG. 4. FIG. 3 is a flow chart diagram illustrating the transportation determining method in an embodiment of the present invention. FIG. 3 is a further and more complete flow chart of FIG. 1, and steps in FIG. 3 can be achieved by the transportation determining and transport fare calculating system S in FIG. 2. FIG. 4 is a simply schematic diagram illustrating a travel route and an electrical map in an embodiment of the present invention, and FIG. 4 is a practical application situation of the transportation determining and transport fare calculating system S. As shown in FIG. 3, in this embodiment, the transportation determining method further includes the following step of: step S13: the server calculating a moving route information of the electronic device according to the moving parameter, and calculating a transport fare according to the moving route information and the transportation type.

In step S13, the analysis unit 23 of the server 2 can calculate the moving route information of the electronic device 1 according to the aforementioned moving parameter. In practice, the moving route information can be the actual movement distance of the electronic device 1, but is not limited thereto. The moving route information can also be the distance between two stay locations. For example, when the analysis unit 23 determines that the moving track of the electronic device 1 is same as the driving route of the bus, the electronic device 1 takes the bus between the first timestamp and the second timestamp, and the first stay location and the second stay location are same as two bus stop signs of the bus, the moving route information of the electronic device 1 is the distance between the two bus stop signs. When the analysis unit 23 determines that the electronic device 1 takes the high-speed rail between the first stay location and the second stay location, and the first stay location and the second stay location are both stops of the high-speed rail, the moving route information of the electronic device 1 is the position/location of the two stops.

Furthermore, as shown in FIG. 2, the transportation determining and transport fare calculating system S further includes a charge calculating unit 24 connected to the analysis unit 23 and configured to calculate the transport fare according to the moving route information and transportation type. In practice, the charge calculating unit 24 can be a calculating chip. The analysis unit 23 and the charge calculating unit 24 also can be integrated in one chip. The charge calculating unit 24 can calculate the transport fare corresponding to the travel route of the travel according to the transportation type and the moving route information determined by the analysis unit 23. In practical application, the transport fare calculated by the charge calculating unit 24 is related to the moving route information but does not necessarily exhibit a proportional linear relationship. The charge calculating unit 24 can calculate the transport fare according to the real moving route information of the electronic device 1 (such as when the electronic device 1 takes taxi). Moreover, the charge calculating unit 24 can generate the transport fare according to the pricing method and mechanism of the transportation type. For example, when the analysis unit 23 determines that the electronic device 1 takes the high-speed rail and the moving route information of the electronic device 1 is two stops, the charge calculating unit 24 can calculate the transport fare according to the fare of the high-speed rail between the two stops.

Therefore, the transportation determining method and the transportation determining and transport fare calculating system of present invention can automatically determine the transportation type taken by the user through real-time positioning and moving parameter detection, and can automatically calculate transport fare according to the moving parameter and the transportation type. The users do not need to spend a lot of time queuing to buy tickets, thereby saving time and improving efficiency and convenience.

The method and system of present invention not only can be applied to aforementioned situations, also can be applied to other situations. As shown in FIG. 3, in this embodiment, the transportation determining method further includes the following steps of: step S101: the electronic device 1 inputting the travel starting signal, wherein the travel starting signal includes a first position and a second position, and a travel route is formed between the first position and the second position; step S102: the server 2 generating at least one recommend transportation according to the travel route; and step S103: the electronic device 1 selecting the at least one recommend transportation according to a user command.

In step S101, the user also can input the first position and the second position through the aforementioned electronic tracking system/platform. In practice, the first position can be the start position of the travel or the current position of the user, and the second position can be the destination position. In practical application, the electronic tracking system/platform also can include route planning function. The electronic tracking system/platform can plan the first position and the second position according to the combination of shortest time, shortest distance, heading method (such as walk and transportation) and/or at least one transportation to establish the travel route between the first position and the second position on the electrical map. Furthermore, the travel route not only can display on the electronic device 1, but also can be sent to the server 2.

In step S102, when receiving the travel route, the server 2 can obtain a plurality of driving route data of transportations from a transportation database. Then, the analysis unit 23 of the server 2 can compare the travel route and the driving route data, and determine the transportation type corresponding to the driving route data with highly similar to the travel route as recommended transportation, and then the server 2 sends the recommended transportation to the electronic device 1.

In step S103, the user can check and select the recommended transportation generated by the server 2 through the electronic device 1 to generate the user command.

As shown in FIG. 2 to FIG. 4, in practical application, the user can input the first position A and the second position B from the electrical map M on the electronic device 1. The electronic tracking system/platform can plan and establish the travel route R on the electrical map M according to the first position A and the second position B, and the analysis unit 23 of the server 2 can generate the recommend transportation according to the travel route R. After the user selects the recommend transportation and the electronic device 1 sends the user command and the travel starting signal, the position detecting unit 22 starts to detect and record the position and timestamp of the first position A and obtain the moving speed of the electronic device 1 of the travel route R. Then, after the analysis unit 23 determines that the user takes train according to the moving parameter of the electronic device 1 and the position detecting unit 22 determines that the electronic device 1 is located at the second position B, the position detecting unit 22 can record the timestamp of the second position B, and the analysis unit 23 can calculate the moving route information according to the timestamps of the first position A and the second position B and the moving speed. Finally, the charge calculating unit 24 can calculate the transport fare corresponding to the travel route R according to the moving route information calculated by the analysis unit 23.

Moreover, as shown in FIG. 2, in this embodiment, the server 2 further can be connected to a database 3. The database 3 can store a plurality of transport data of transportation, such as timetables, charge lists, travel routes, etc. In practice, after the position detecting unit 22 records the timestamps of the electronic device 1 located on the first position A and the second position B and the analysis unit 23 calculates the moving route information, the charge calculating unit 24 can compare timestamps of first position A and the second position B, moving route information and transport data of the database 3 to calculate and generate the transport fare corresponding to the travel route R.

Therefore, the transportation determining method and the transportation determining and transport fare calculating system of present invention can automatically calculate transport fare according to the electrical map, the moving parameter and the transportation type. The users do not need to spend a lot of time queuing to buy tickets, thereby saving time and improving efficiency and convenience.

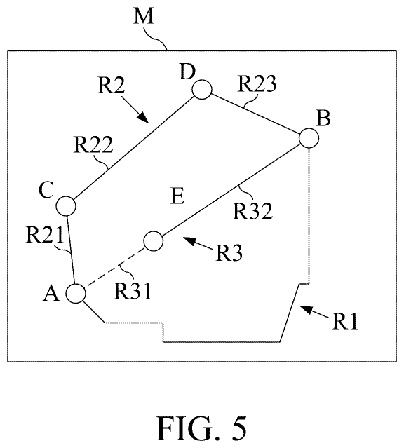

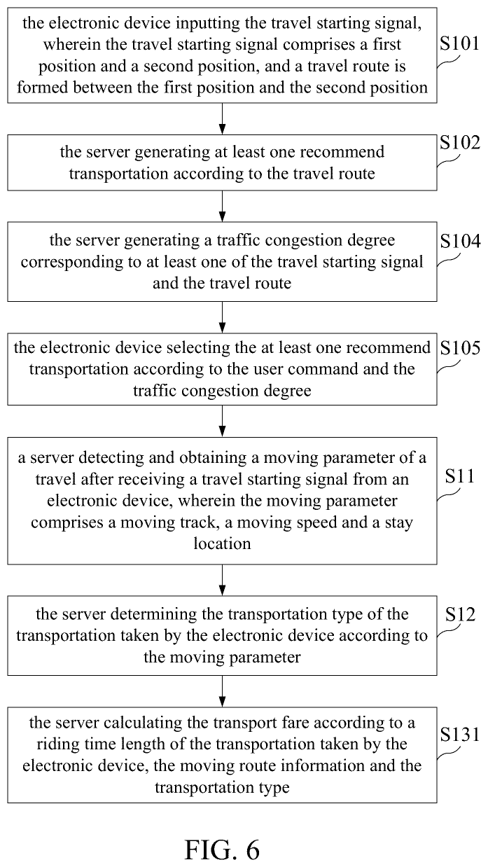

Please Refer to FIG. 2, FIG. 5 and FIG. 6. FIG. 5 is a simply schematic diagram illustrating the travel routes and the electrical map in an embodiment of the present invention. FIG. 6 is a flow chart diagram illustrating the transportation determining method in an embodiment of the present invention. FIG. 5 shows various practical application situations of the transportation determining and transport fare calculating system S. The steps in FIG. 6 can be achieved by the transportation determining and transport fare calculating system S in FIG. 2, and the steps in FIG. 6 are further steps of FIG. 3. As shown in FIG. 5, in this embodiment, when the electronic device 1 inputs the first position A and the second position B, the electronic tracking system/platform can mark the first position A and the second position B on the electrical map M and establish three travel routes (including a first travel route R1, a second travel route R2 and a third travel route R3). The first travel route R1 is same as the driving route of the bus, and the recommend transportation is the bus. Furthermore, the electronic tracking system/platform also can generate at least one sub-route according to the travel route. As shown in FIG. 5, the second travel route R2 includes a first sub-route R21, a second cub route R22 and a third sub-route R23. Wherein, a third position C is located between the first sub-route R21 and the second cub route R22, and a fourth position D is located between the second cub route R22 and the third sub-route R23. Furthermore, the first sub-route R21, the second cub route R22 and the third sub-route R23 can be corresponding different recommend transportations respectively (such as combination of bus, train and high-speed rail or buses on different routes). Moreover, the electronic tracking system/platform also can recommend different moving method according to the travel route. As shown in FIG. 5, the third travel route R3 includes a fourth sub-route R31 and a fifth sub-route R32, and a fifth position E is located between the fourth sub-route R31 and the fifth sub-route R32. Wherein, the fourth sub-route R31 is recommended by walking, and the recommend transportation corresponding to the fifth sub-route R32 is the bus.

In practical application, the user can select one of the first travel route R1, the second travel route R2 and the third travel route R3 through the input unit 11 of the electronic device 1 as the path heading to the destination to generate the user command. When the server 2 receives the user command which selects the second travel route R2, the position detecting unit 22 can record the timestamps of the electronic device 1 located at the first position A, the third position C, the fourth position D and the second position B respectively, and the analysis unit 23 can calculate the moving route information of the first sub-route R21, the second sub-route R22 and the third sub-route R23 respectively. The charge calculating unit 24 can calculate and count the transport fares of the first sub-route R21, the second sub-route R22 and the third sub-route R23 to generate the total transport fare of the second travel route R2.

In addition, the user command inputted by the user through the electronic device 1 can also only select at least one sub-route. When the server 2 receives the user command which selects the second sub-route R22 and the third sub-route R23 of the second travel route R2, the position detecting unit 22 only records the timestamps of the electronic device 1 located at the third position C, the fourth position D and the second position B respectively, but will not record the timestamp of the first position A. The analysis unit 23 only calculates the moving route information of the second sub-route R22 and the third sub-route R23 respectively, but will not calculate the moving route information of the first sub-route R21. The charge calculating unit 24 only calculates and counts the transport fares of the second sub-route R22 and the third sub-route R23 to generate the total transport fare.

When the server 2 receives the user command which selects the third travel route R3, the position detecting unit 22 records the timestamps of the electronic device 1 located at the fifth position E and the second position B respectively, but will not record the timestamp of the first position A. The analysis unit 23 only calculates the moving route information of the fifth sub-route R32, but will not calculate the moving route information of the fourth sub-route R31. The charge calculating unit 24 calculates and counts the transport fare of the fifth sub-route R32 to generate the total transport fare of the third travel route R3.

As shown in FIG. 2 and FIG. 6, the transportation determining method further includes the following step after step S102 of: step S104: the server 2 generating a traffic congestion degree corresponding to at least one of the travel starting signal and the travel route; and the step S103 further includes the following step of: step S105: the electronic device 1 selecting the recommend transportation according to the user command and the traffic congestion degree.

In step S104, the position detecting unit 22 of the server 2 not only receives the travel starting signal and the travel route sent by the electronic device 1, but also receives the travel starting signals and the travel routes of other electronic devices. Furthermore, the analysis unit 23 of the server 2 can calculate and count the number of the second position (that is the destination) and/or the same travel route in the travel starting signals to generate a traffic congestion degree. In practice, when the number of the second position and the same travel route is greater, it means that the destination and the travel route will generate greater traffic flow. At this time, the analysis unit 23 can mark colors on the travel route and/or the second position to predict traffic congestion degree. For example, the red color indicates high traffic congestion degree, and the green color indicates low traffic congestion degree. In practical application, the analysis unit 23 also can present the traffic congestion degree in text, graphic or other ways. The server 2 can send the traffic congestion degree to the electronic device 1. In step S105, the user can select and input the transportation and travel route for heading to the destination according to the traffic congestion degree of the travel route or sub-route.

In this embodiment, the step S103 further includes the following step of: step S131: the charge calculating unit 24 of the server 2 calculating the transport fare according to a riding time length of the transportation taken by the electronic device 1, the transportation type and the moving route information. In practice, the riding time length can correspond to a discounted fare. The ride time length is longer, the discounted fare is greater. When the position detecting unit 22 detects the timestamp of the electronic device 1 located at each position, the position detecting unit 22 also will detect whether the timestamp is located during peak hours (for example, during commuting and off-duty hours, holidays, or times when traffic is relatively congested). As shown in FIG. 4 as example, when the position detecting unit 22 detects that the timestamp of the electronic device 1 located at the first position A is peak hour and the ride time length is longer, the charge calculating unit 24 can calculate the total transport fare according to the transport fare corresponding to the moving route information of the travel route R and the discounted fare.

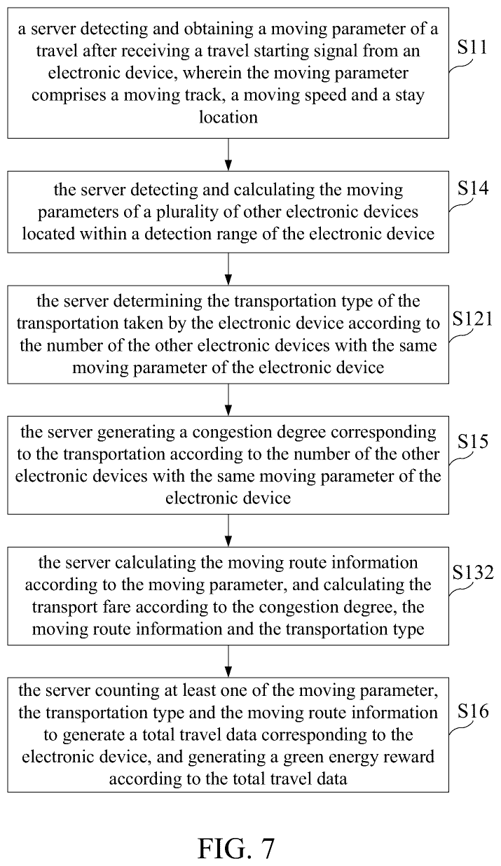

The method and system of the present invention also can determine the transportation type by other ways. Please refer to FIG. 2 and FIG. 7. FIG. 7 is a flow chart diagram illustrating the transportation determining method in an embodiment of the present invention. The steps in FIG. 7 can be achieved by the transportation determining and transport fare calculating system S in FIG. 2. As shown in FIG. 2 and FIG. 7, in this embodiment, the transportation determining method further includes the following step of: step S14: the server 2 detecting and calculating the moving parameters of a plurality of other electronic devices located within a detection range of the electronic device 1; and the step S12 in FIG. 3 further includes the following step of: step S121: the server 2 determining the transportation type of the transportation taken by the electronic device 1 according to the number of the other electronic devices with the same moving parameter of the electronic device 1.

In step S14, the position detecting unit 22 of the server 2 can pre-store an electronic device threshold value and is configured to detect and calculate the number of the other electronic devices located within a detection range of the electronic device 1. The analysis unit 23 can determine the transportation type according to the aforementioned moving parameter, the electronic device threshold value and the number of the other electronic devices. In practice, the electronic device threshold value can be 5, and the detection range can be an area enclosed by a distance of 5 meters from the electronic device 1, but it is not limited thereto. When the position detecting unit 22 detects that the average moving speeds of the other electronic device are same as the electronic device 1 and the number of the other electronic devices is greater than the electronic device threshold value, it means that the user takes the public transportation (such as the bus). Moreover, when the position detecting unit 22 detects that the average moving speeds of the other electronic device are same as the electronic device 1 and the number of the other electronic devices is smaller than the electronic device threshold value, it means that the user takes the small transportation (such as the taxi). As shown in FIG. 2 and FIG. 5, in practical application, when the server 2 receives the user command which selects the second travel route R2 and the analysis unit 23 determines that the electronic device 1 takes the taxi on the first sub-route R21, the charge calculating unit 24 will calculate and count the transport fares of the second sub-route R22 and the third sub-route R23 to generate the total transport fare of the second travel route R2.

Moreover, when the position detecting unit 22 detects and calculates the number of the other electronic devices located within the detection range of the electronic device 1, the position detecting unit 22 also can record the device information of the other electronic devices (such as IP address, MAC address, serial number). Furthermore, when the position detecting unit 22 detects that the distances among the electronic device 1 and the other electronic devices are greater than or out of the detection range, it means that the user is not at the same location as other people. At this time, the analysis unit 23 will determine that the user gets off the transportation. Then, the position detecting unit 22 also can obtain the current stay location of the electronic device 1, and the charge calculating unit 24 will calculate the transport fare.

In this embodiment, the transportation determining method further includes the following step of: step S15: the server 2 generating a congestion degree corresponding to the transportation according to the number of the other electronic devices with the same moving parameter of the electronic device 1; and the step S13 in FIG. 3 further includes the following step of: step S132: the server 2 calculating the transport fare according to the congestion degree, the moving route information and the transportation type.

In step S51, the position detecting unit 22 of the server 2 can detect and calculate the number of the other electronic devices located within the detection range of the electronic device 1, and the analysis unit 23 can determine the congestion degree of the transportation according to the number of the other electronic devices. When the number of the other electronic devices is greater, the congestion degree of the transportation is higher. In step S132, the congestion degree of the transportation also can correspond to a discounted fare. The congestion degree is higher, the discounted fare is greater.

In this embodiment, the transportation determining method further includes the following step of: step S16: the charge calculating unit 24 of the server 2 counting at least one of the moving parameter, the transportation type and the moving route information to generate a total travel data corresponding to the electronic device 1, and generating a green energy reward according to the total travel data. In practice, after the user uses the electronic device 1 to go to the destination through the system of the present invention, the charge calculating unit 24 can count the total taking number and taking time of the transportation and the total mileage of moving route information of the electronic device 1 takes, and then generate total travel data corresponding to the electronic device 1. Furthermore, the charge calculating unit 24 can pre-store a plurality of reward threshold value, for example: the total number of rides is 50 times, the total mileage is 100 kilometers, etc. When the total travel data of the electronic device 1 reaches the reward threshold value, the charge calculating unit 24 can generate the green energy reward corresponding to the reward threshold value, and then the server 2 sends the green energy reward to the electronic device 1. The green energy reward can include discount coupons and free ride coupons, but it is not limited thereto. The user can use the green energy reward before using the system of the present invention and paying the transport fare next time, and the charge calculating unit 24 can calculate a new transport fare according to the transport fare and the green energy reward.

Moreover, the charge calculating unit 24 also can generate the green energy reward according to a total walking data. In practice, the position detecting unit 22 can detect that the user is walking according to the moving speed, and the analysis unit 23 can determine the walking distance according to the moving parameter. The charge calculating unit 24 can pre-store the reward threshold value corresponding to the total walking data. When the total walking data of the electronic device 1 reaches the reward threshold value, the charge calculating unit 24 also can generate and send the green energy reward to the electronic device 1, thereby increasing green energy and promoting user's health.

In summary, the transportation determining method and the transportation determining and transport fare calculating system of the present invention have four major functional features of: comprehensively promote convenience, fairness, prediction and green energy. The transportation determining method and the transportation determining and transport fare calculating system can automatically determine the transportation type taken by the user through real-time positioning and moving parameter detection, and can automatically calculate transport fare according to the electrical map, the moving parameter and the transportation type. The users do not need to spend a lot of time queuing to buy tickets, thereby saving time and improving efficiency and convenience. Furthermore, the transportation determining method and the transportation determining and transport fare calculating system can present the traffic congestion degree of each travel route and the congestion degree of the transportation immediately, and the user can select transportation according to the congestion degree, thereby increasing the usability and predictability. Moreover, the transportation determining method and the transportation determining and transport fare calculating system also can adjust transport fare according to the congestion degree and/or riding time length taken by the user, thereby increasing fairness and comfort.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A transportation determining method, comprising the following steps of:
a server detecting and obtaining a moving parameter of a travel after receiving a travel starting signal from an electronic device, wherein the moving parameter comprises a moving track, a moving speed and a stay location; and
the server determining a transportation type of a transportation taken by the electronic device according to the moving parameter.

2. The method of claim 1, further comprising the following step of:
the server calculating a moving route information of the electronic device according to the moving parameter, and calculating a transport fare according to the moving route information and the transportation type.

3. The method of claim 1, further comprising the following steps of:
the electronic device inputting the travel starting signal, wherein the travel starting signal comprises a first position and a second position, and a travel route is formed between the first position and the second position;
the server generating at least one recommend transportation according to the travel route; and
the electronic device selecting the at least one recommend transportation according to a user command.

4. The method of claim 3, further comprising the following step of:
the server generating a traffic congestion degree corresponding to at least one of the travel starting signal and the travel route;
and, in the step of the electronic device selecting the at least one recommend transportation according to the user command, further comprising the step of:
the electronic device selecting the at least one recommend transportation according to the user command and the traffic congestion degree.

5. The method of claim 2, in the step of the server calculating the transport fare according to the moving route information and the transportation type, further comprising the step of:
the server calculating the transport fare according to a riding time length of the transportation taken by the electronic device, the moving route information and the transportation type.

6. The method of claim 1, further comprising the following step of:
the server detecting and calculating the moving parameters of a plurality of other electronic devices located within a detection range of the electronic device;
and, in the step of the server determining the transportation type of the transportation taken by the electronic device according to the moving parameter, further comprising the following step of:
the server determining the transportation type of the transportation taken by the electronic device according to the number of the other electronic devices with the same moving parameter of the electronic device.

7. The method of claim 6, further comprising the following steps of:
the server generating a congestion degree corresponding to the transportation according to the number of the other electronic devices with the same moving parameter of the electronic device; and
the server calculating a moving route information according to the moving parameter, and calculating a transport fare according to the congestion degree, the moving route information and the transportation type.

8. The method of claim 2, further comprising the following steps of:
the server counting at least one of the moving parameter, the transportation type and the moving route information to generate a total travel data corresponding to the electronic device, and generating a green energy reward according to the total travel data.

9. A transportation determining and transport fare calculating system, comprising:
an electronic device, comprising an input unit configured to input a travel starting signal;
a server, communicated with the electronic device and configured to receive the travel starting signal, the server further comprising:
a position detecting unit, configured to detect and obtain a moving parameter of a travel of the electronic device according to the travel starting signal, wherein the moving parameter comprises a moving track, a moving speed and a stay location;
an analysis unit, connected to the position detecting unit, the analysis unit being configured to determine a transportation type of a transportation taken by the electronic device and a moving route information of the electronic device according to the moving parameter; and
a charge calculating unit, connected to the analysis unit, the charge calculating unit being configured to calculate a transport fare according to the moving route information and the transportation type.

10. The system of claim 9, wherein the travel starting signal comprises a first position and a second position, and a travel route is formed between the first position and the second position, the analysis unit is configured to generate at least one recommend transportation according to the travel route, the electronic device is configured to select the at least one recommend transportation according to a user command.

11. The system of claim 10, wherein the analysis unit is configured to generate a traffic congestion degree corresponding to at least one of the travel starting signal and the travel route, and the electronic device is configured to select the at least one recommend transportation according to the user command and the traffic congestion degree.

12. The system of claim 9, wherein the charge calculating unit is connected to the position detecting unit, and the position detecting unit is configured to record a riding time length of the transportation taken by the electronic device, the charge calculating unit is configured to calculate the transport fare according to the riding time length, the moving route information and the transportation type.

13. The system of claim 9, wherein the position detecting unit is configured to detect and calculate the moving parameters of a plurality of other electronic devices located within a detection range of the electronic device, and the analysis unit is configured to determine the transportation type according to the number of the other electronic devices with the same moving parameter of the electronic device.

14. The system of claim 13, wherein the analysis unit is configured to generate a congestion degree corresponding to the transportation according to the number of the other electronic devices with the same moving parameter of the electronic device, and the charge calculating unit is configured to calculate the transport fare according to the congestion degree, the moving route information and the transportation type.

15. The system of claim 9, wherein the charge calculating unit is configured to count at least one of the moving parameter, the transportation type and the moving route information to generate a total travel data corresponding to the electronic device, and generate a green energy reward according to the total travel data.
